(19) United States
(12) Patent Application Publication
(10) Pub. No.: US 2009/0277077 A1
(43) Pub. Date: Nov. 12, 2009

(54) BIODIESEL FUEL AND METHOD OF MANUFACTURE THEREFOR

(76) Inventors: Rodney J. Gleason, Highland, MI (US); Albert S. Worrell, Milford, MI (US)

Correspondence Address: Arnold S. Weintraub;The Weintraub Group, Suite 140, 28580 Orchard Lake Road, Farmington, MI, 48334, US

(21) Appl. No.: 12/432,203

(22) Filed: Apr. 29, 2009

Related U.S. Application Data
(63) Continuation-in-part of application No. 12/074,441, filed on Mar. 4, 2008.
(60) Provisional application No. 60/904,946, filed on Mar. 5, 2007.

(51) Int. Cl. C10L 1/19; B01J 19/24

(52) U.S. Cl. 44/388; 422/198

(57) ABSTRACT

A method for producing biofuel by a transesterification reaction of an alcohol and a triglyceride such as an oil or fat is carried out at supercritical conditions in a reactor using a stoichiometric excess of alcohol. The reaction products of biofuel and gaseous mixture of glycerin and alcohol are re-cycled through a series of heat exchangers which transfer heat to respective pre-heaters to sequentially raise the temperature and pressure of the reaction mixture prior to delivery to the reactor. Any excess alcohol after separating and recovering gaseous glycerin therefrom is recycled and mixed with “fresh” alcohol. Preferably, the process is a non-catalytic continuous process.

### CROSS-REFERENCE TO RELATED APPLICATIONS

This application is a continuation-in-part of co-pending U.S. application Ser. No. 12/074,441, filed Mar. 4, 2008, which claims the benefit of U.S. Provisional Application No. 60/904,946, filed Mar. 5, 2007, for “Biodiesel Fuel and Method of Manufacture,” the entire disclosure of which is hereby incorporated by reference.

### BACKGROUND OF THE INVENTION

1. Field of the Invention

The present invention pertains to biodiesel fuels. More particularly, this invention relates to the manufacture of biodiesel fuels. Even more particularly, the present invention pertains to a transesterification process for the manufacture of biodiesel fuels and methods of recovery therefor.

2. Description of the Prior Art

As is known to those skilled in the art to which the present invention pertains, growth in the utilization of biodiesel fuels has proliferated. With the demand for reduction in petroleum oil consumption there is a growing recommendation for turning to renewable fuel sources. In this regard, the art has developed means and methods for the manufacture of biofuel and, in particular, biodiesel fuels.

Generally, such fuels are prepared by the transesterification of a triglyceride(s) either: (a) in the presence of a catalyst; or (b) by using the alcohol in a supercritical condition. In a transesterification reaction, usually, a fat or oil from any suitable source, such as corn oil or the like, is reacted with the alcohol to form a fatty acid ester which can then be successfully deployed as a fuel. This transesterification process is well-known, such as described in U.S. Pat. Nos. 6,570,030, 6,187,939, and 6,090,959; as well as U.S. Publication No. 2006/0025620, the disclosures of which are hereby incorporated by reference.

However, the efficiency of such processes is not satisfactory. In the catalytic reaction, because of the presence of the catalyst and the potential for soap by-products, the efficiency of such a reaction system is somewhat degraded. Similarly, in the non-catalytic reaction, because excess stoichiometric quantities of alcohol are used, the economics of the process lessen the practicality of using same.

Thus, there exists a need for improvements in the manufacturing process whereby the excess reactants can be recycled and reused. It is this to which the present invention is directed.

### SUMMARY OF THE INVENTION

In accordance with the present invention, a biofuel is prepared by the transesterification of a triglyceride, i.e. fat or oil with an alcohol, the alcohol being in a supercritical state.

According to the present invention, and in a preferred embodiment, a stoichiometric excess of an alcohol is reacted with a vegetable oil in a suitable reactor which is maintained at supercritical conditions, i.e. at a temperature above about 180° C. and a pressure greater than about 1450 psi. Prior to delivering the reactants to the reactor, the alcohol is passed through a series of pre-heaters. The pre-heaters use recycled reaction products to pre-heat the alcohol.

According to the present invention, after leaving the reactor, a portion of the reactor products are passed into a heat exchanger to transfer heat to a proximal pre-heater and then on to a first flash drum which condenses the biodiesel fuel while leaving the excess alcohol and glycerol by-product in a gaseous state. Liquid fuel is collected from the bottom of the drum and sent into another heat exchanger which transfers heat to a first intermediate pre-heater. The liquid fuel is then collected, while the alcohol and glycerol are transferred to an additional heat exchanger which transfers heat to a second intermediate pre-heater, and then into a second flash drum.

The second flash drum is then set to a temperature and pressure that causes the glycerol to condense, while leaving the alcohol in a gaseous state. The glycerol is collected from the second drum and the gaseous alcohol is then recycled, condensed, and mixed with fresh alcohol which, in turn, is then pumped into the reactor through the pre-heaters.

Preferably, the reaction is a continuous process, although a batch process could be employed.

It should be noted that although the catalytic reaction can be used, it is preferred that the supercritical reaction be employed for efficiency and not having to recover the catalyst.

For a more complete understanding of the present invention, reference is made to the following detailed description and accompanying drawing. In the drawing, like reference characters refer to like parts throughout the several view in which:

### BRIEF DESCRIPTION OF THE DRAWINGS

FIG. 1 is a flow chart showing a first embodiment of the present process;

FIG. 2 is a flow chart showing a second embodiment hereof; and

FIG. 3 is a perspective view of the present invention assembled on a mobile platform.

### DETAILED DESCRIPTION OF THE PREFERRED EMBODIMENT

As noted above, the present invention contemplates a continuous process wherein an alcohol and a triglyceride, i.e. an oil or a fat, are reacted together in a suitable reactor or furnace, wherein the furnace maintains the alcohol at a supercritical temperature, i.e. above 180° C. and at a pressure greater than about 1450 psi.

More particularly, and in a first embodiment hereof, the present invention contemplates an alcohol or source which is passed through a series of pre-heaters, mixed together with a triglyceride source, and the resulting admixture is then pumped, under pressure, into a reactor maintained at an elevated temperature and pressure.

Prior to entering the reactor, the alcohol is fed through a series of pre-heaters. The pre-heaters use the heat of the reactants to pre-heat the alcohol by recycling the reactants. Thus, after the reaction is complete, the reactants then pass through a first proportioning valve. The first proportioning valve directs a first proportion of the reactants into a heat exchanger which transfers heat to a proximal pre-heater and, therefrom, into a first flash drum. The first proportioning valve also directs a second proportion of the reactants directly into the first flash drum. The volumes of the first and second proportions are determined by adjusting the first proportioning valve settings. The settings of the first proportioning valve can be manually adjusted.

The biodiesel fuel is condensed in the first drum while gaseous alcohol and glycerol by-product remain in the gaseous state. The biofuel is transferred through a heat exchanger which transfers heat to a second intermediate pre-heater so as to pre-heat the alcohol therein. The biofuel is then drawn off and collected.

The gaseous components exiting the first flash drum then pass through a second proportioning valve. The second proportioning valve directs a first proportion of the gaseous components into a heat exchanger that transfers heat to a second intermediate pre-heater and, therefrom, into a second flash drum. The second proportioning valve also directs a second proportion of the gaseous components directly into the second flash drum. The volumes of the first and second proportions are determined by the settings of the second proportioning valve, which may be manually adjusted as well.

In the second flash drum the glycerol is condensed, drawn off, and collected while the alcohol remains in a gaseous state. The gaseous alcohol is then passed through an additional heat exchanger to liquefy the alcohol, and then recycled into an alcohol feed tank and mixed with fresh alcohol.

In carrying out the reaction, the first component, as noted, is an alcohol or alkanol. Typically, these alcohols correspond to the formula:

CₙH₂ₙ₋₁(OH)

wherein n ranges from about one to about ten and, preferably, from about one to about four.

Among the useful alcohols are methanol, ethanol, n-propanol, isopropanol, n-butanol, isobutanol and the like, as well as mixtures thereof.

Preferred alcohols are methanol, ethanol, n-propanol, isopropanol and the like and mixtures thereof. Most preferred is methanol, alone, or in admixture with any of the other alkanols.

Where an alcohol admixture is used, the admixture will comprise a methanol to other alkanol volumetric ratio of about 99:1 to about 1:99, and preferably, at least a 50:50 volumetric ratio of methanol to other alkanol.

The second component in the present process comprises a triglyceride(s), i.e. a fat or oil. Useful and preferred are vegetable oils derived from renewable sources such as corn, soybean, rapeseed or the like. However, other vegetable oils can be used such as sunflower seed oil, peanut oil, and the like. Preferably, because of its abundance, soybean oil is used.

Useful fats include animal fat.

In carrying out the reaction, a stoichiometric excess of alcohol is used to ensure maximum transesterification, i.e. about 95%.

By carrying out the reaction in a supercritical state, usually at a temperature greater than 180° C. and at a pressure greater than about 1450 psi, the need for a catalyst is eliminated.

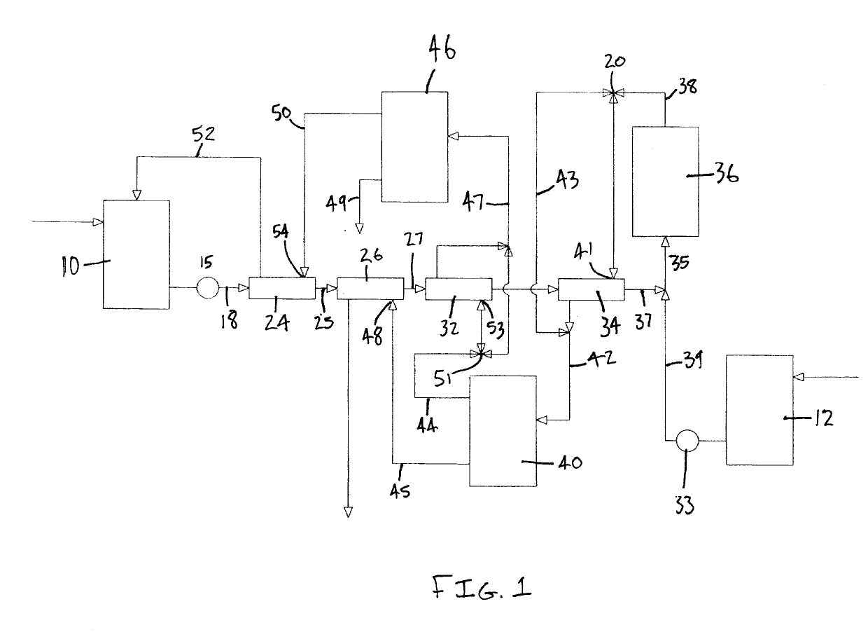

Referring now to the drawings and, in particular to FIG. 1, there is shown a flow chart for carrying out a first embodiment of the present process. As shown, initially, there is provided an alcohol source and a triglyceride source, comprising feed tanks, 10 and 12, respectively.

The alcohol is pumped under pressure, via pump 15, through delivery line 18 and into a distal pre-heater 24. The distal pre-heater 24 elevates the alcohol to a temperature below the supercritical temperature and a pressure below 1450 psi.

As shown, the pre-heater 24 is in fluid communication with a first intermediate pre-heater 26 via delivery line 25. Delivery line 25 feeds the first intermediate pre-heater 26 via the pump 15. In the first intermediate pre-heater 26, the alcohol is further heated to a temperature, but still below about 180° C., while maintaining an elevated pressure, but below 1450 psi.

As explained subsequently hereinbelow, each of the pre-heaters uses a countercurrent flow heat exchanger to transfer heat through a recycling of reaction products.

From the first intermediate pre-heater 26, the reaction mixture is, preferably, transferred to a second intermediate pre-heater 32 via delivery line 27 where the temperature of the reaction mixture is elevated still higher but below the flash temperature of the alcohol while still maintaining a pressure below 1450 psi.

Still referring to FIG. 1, the heated and pressurized alcohol is then transferred or delivered to a proximal pre-heater 34 where the alcohol is further heated while still elevating the pressure. The alcohol exits the proximal pre-heater 34 via a delivery line 37.

The triglyceride is pumped from the feed tank 12 by a pump 33 through a delivery line 39. The alcohol and triglyceride are directed into a common delivery line 35. The alcohol and triglyceride are mixed together as they enter the common delivery line 35, thus forming an admixture, or reactants, before entering the reactor or furnace 36.

As noted, the reactor 36 is a continuous reactor maintained at supercritical conditions, i.e. at a pressure greater than about 1450 psi and at a temperature greater than 180° C., and preferably, greater than 300° C. The reactor 36 is equipped with means for stirring, such as a static mixer (not shown), to ensure that the reactants are maintained in turbulent mixing to ensure contact therebetween.

Depending on the flow rates into the reactor 36, the reaction is usually complete within about 5 to about 10 minutes. The resulting reaction product is a biofuel and glycerol-alcohol gaseous mixture.

The reaction products then flow, under pressure, to a first proportioning valve 20 via delivery line 38.

Proportioning valves are well known and commercially available and, generally, comprise a valve capable of distributing input flows into one or more output lines. A proportioning valve can be adjusted to increase or decrease the flow into each of the output lines. The proportioning valves provided herein can divert between 0% and 100% of the total flow to any output line. The proportioning valves are provided in the present invention to regulate the temperature of reaction products entering the flash drums, as is discussed in more detail below.

The first proportioning valve 20 directs a first proportion of the reaction product into a proximal heat exchanger 41 which provides some of the reaction's heat to the proximal pre-heater 34. The proximal heat exchanger 41, as well as additional heat exchangers mentioned below, is discussed in further detail hereinbelow. The proximal heat exchanger 41 transfers heat from the reaction product to the alcohol in the proximal pre-heater 34. The first proportion of the reaction product is then transferred from the proximal heat exchanger 41 to a first flash drum 40 via delivery line 42.

The first proportioning valve 20 also directs a second proportion of the reaction product to bypass the proximal heat exchanger 41 and to enter the first flash drum 40 via delivery line 43.

Flash drums are well known and commercially available and, generally, comprise an elongated tubular member having separation plates contained therewithin to permit liquid condensates to be collected at the bottom of the drum with the gaseous components rising to the top.

Generally, in the practice of the present invention, the first flash drum 40 is maintained at a temperature less than that of the reactor, i.e. from about 280° C. to about 290° C. and at a pressure less than that of the reactor pressure but greater than atmospheric. In this manner, the hot liquid alkyl fatty acid ester biofuel condenses and is collected at the bottom of the drum and withdrawn therefrom and recycled into a first intermediate heat exchanger 48 which is paired with the first intermediate pre-heater 26 via delivery line 45, thereby transferring additional heat to the alcohol. The biofuel exits the first intermediate heat exchanger 48 and is then collected.

The excess alcohol and glycerol in the first flash drum 40 remain in a gaseous state and are transported through a delivery line 44 to a second proportioning valve 51. The second proportioning valve 51 directs a first proportion of the gaseous components into a second intermediate heat exchanger 53 which is paired with the second intermediate pre-heater 32. The second intermediate heat exchanger 53 transfers some of the gaseous components' heat to the alcohol. After the heat transfer, the glycerol-alcohol mixture remains gaseous. The gaseous components are then transferred from the second intermediate heat exchanger 53 to a second flash drum 46 via delivery line 47.

The second proportioning valve 51 also directs a second proportion of the gaseous components to bypass the second intermediate heat exchanger 53 and to enter the second flash drum 46 via delivery line 47.

The second flash drum 46 is similar to the first flash drum 40. The second flash drum 46 is maintained at a temperature ranging from about 66° C. to about 289° C. and at a pressure less than that of the first flash drum 40 but greater than atmospheric. In the second flash drum 46, glycerol is condensed and collected at the bottom 49 while gaseous alcohol is further recycled.

As shown, the alcohol exits the second flash drum 46 via delivery line 50 which then directs the alcohol into a distal heat exchanger 54 which is paired with the distal pre-heater 24. The distal heat exchanger 54 transfers sufficient heat from the gaseous alcohol to the alcohol in the distal pre-heater 24 such that the gaseous alcohol condenses into a liquid. The recovered liquid alcohol is, then, recycled to the feed tank 10 via delivery line 52, and admixed with fresh alcohol thereat.

According to the present method, the recovery of and reuse of the stoichiometric excess of alcohol lowers the amount of “fresh” alcohol necessary to be used in the reaction, while effectively recovering the biofuel.

Furthermore, the heat transferred to the pre-heaters reduces the amount of heat lost in the reaction by-products, thereby increasing the energy efficiency of the entire process.

In addition, glycerol, which is recovered as a by-product, can then be used for various other compositions in which glycerol or glycerin is a component.

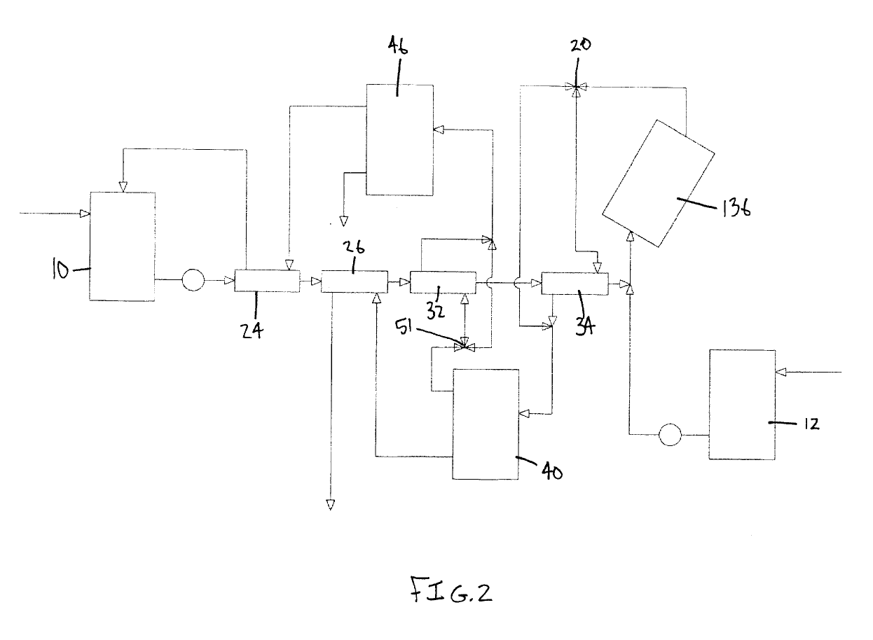

In a second embodiment hereof, and as shown in FIG. 2, an angled reactor 136 is provided. The reactor 136 is angled with respect to its vertical orientation so as to provide an increased surface area for the reactants contained therein. In all other respects the process is the same as described with respect to the first embodiment.

It is noted that the reactants flow through the system, preferably, in a turbulent state.

It is further noted that each of the pre-heaters comprises a counter-current or counterflow heat exchanger. Such are well known and commercially available and, generally, include concentric tubes formed from a suitable non-reactive material having sufficient thermal conductively to enable sufficient heat transfer from the reaction product(s) to the reactants. Any such heat exchanger can be used herein so long as it withstands the processing parameters and is non-reactive.

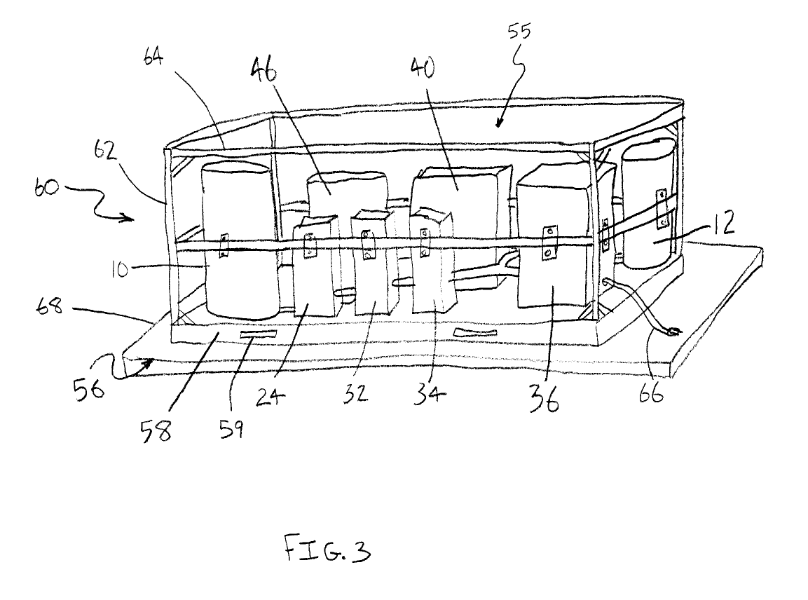

As shown in FIG. 3, it is appreciated that an apparatus 55 for performing the method described hereinabove may be assembled as a single mobile unit 56 which is portable from one location to another. The mobile unit 56 includes, but is not limited to, a portable platform 58, the apparatus 55, and a structural support 60. The apparatus 55 includes, but is not limited to, components such as the feed tanks, flash drums, pre-heaters, proportioning valves, and reactor.

The platform 58 is preferably substantially rectangular in shape, and has substantially planar upper and lower surfaces. It may be formed from any suitable material, such as wood, metal, plastic, or the like. The platform 58 must be sufficiently rigid to provide support, to the mobile unit 56, however, it is noted that the platform 58 should be light enough so that it does not impede portability. The platform 58 may be moved by a forklift or the like, and preferably, it has means for receiving forks 59 from a fork lift. The means for receiving forks may be through-slots extending into the platform 58, recesses along the lower surface of the platform 58 to receive the forks between the platform 58 and the ground, or any other suitable means which are well known to one of ordinary skill in the art.

The mobile unit 56 also comprises a structural support 60 which may be formed from metal, plastic, wood, or the like. The structural support 60 includes a plurality of vertically-oriented pillars 62 and a plurality of horizontally-oriented struts 64. The pillars 62 extend upwardly from the platform 58 and are secured thereto by means which are well known in the art, for instance, by welding, bolts and nuts, fasteners, or the like. The horizontally-oriented struts 64 act as crossbeams which extend generally horizontally between the pillars 62. The pillars 62 and struts 64 are secured or affixed to each other at their respective intersections by suitable means which are well known in the art, such as brackets, nuts, bolts, welding, brackets, and so forth.

The apparatus 55 includes components such as the feed tanks, flash drums, pre-heaters, proportioning valves, and reactor. The components of the apparatus 55 are secured to the structural support 60 so that they do not shift while the mobile unit 56 is being moved. The components of the apparatus 55 are secured to the structural support 60 and/or the platform 58 by means which are well known in the art, such as metal straps, brackets, bolts, nuts, and the like. Furthermore, the components of the apparatus 55 are secured into the mobile unit 56 such that they are sufficiently braced for transport from one location to another.

The mobile unit 56 may also comprise suitable hook-up connections 66 required for operation of the components of the apparatus 55, such as electricity, gas, compressed air, or the like. Each of the hook-up connections 66 are operably connected to their respective component of the apparatus 55. For instance, the reactor 36 may include either a gas or electrical connection, and venting, possibly, as well. As such, the mobile unit 56 provides suitable hook-up connections 66 to components of the apparatus 55 as is well known to those having skill in the art.

It is also to be appreciated that the mobile unit 56 includes any other necessary elements to enable the apparatus 55 to carry out the method for manufacturing biofuel as described above. For instance, any items, such as pumps or delivery lines, which are described hereinabove, are included in the mobile unit 56 as well.

The mobile unit 56 is intended for use in which it may be easily moved and quickly and readily hooked-up for use. Therefore, the platform 58 is designed so that the mobile unit 56 may be easily and quickly placed onto a vehicle 68 for relocation, such as the flatbed of a truck.

From the preceding, it is apparent that there has been described herein an improved process for the production of biodiesel fuel.

It is contemplated that the present method will enable a 95% conversion rate. It should be noted that typically the alcohol and oil will be used in about a 2:1 feed rate into the reactor to provide the requisite excess alcohol.

As noted above, a batch process, with the same process parameters, can be used with the amounts of reactants adjusted to accommodate the necessary stoichiometric excess of alcohol, while still recovering and recycling same.

Having thus described the invention what is claimed is:

1. A method for manufacturing a biofuel by a transesterification process comprising:
(a) providing an alcohol source;
(b) providing a triglyceride source;
(c) mixing together a triglyceride and an alcohol to form a reaction mixture;
(d) transferring the reaction mixture to at least a distal pre-heater to heat the mixture to a temperature below about 180° C. and at a pressure of below about 1450 psi;
(e) transferring the pre-heated reaction mixture to a reactor maintained at a temperature of greater than about 180° C. and at a pressure greater than 1450 psi to form:
(1) a liquid biofuel and
(2) a glycerine and excess alcohol gaseous mixture;
(f) collecting the so-produced biofuel;
(g) collecting the glycerine, and;
(h) recycling the excess alcohol to the alcohol source.

2. A method for manufacturing a biofuel by a transesterification process comprising:
(a) providing an alcohol source;
(b) providing a triglyceride source;
(c) transferring an alcohol to at least a distal pre-heater to heat the alcohol to a temperature below about 180° C. and at a pressure of below about 1450 psi;
(d) mixing together a triglyceride and the alcohol to form a reaction mixture;
(e) providing a reactor, and transferring the pre-heated reaction mixture to the reactor which is maintained at a temperature of greater than about 180° C. and at a pressure greater than 1450 psi to form:
(1) a liquid biofuel and
(2) glycerin and excess alcohol gaseous mixture;
(f) collecting the so-produced biofuel;
(g) collecting the glycerin, and;
(h) recycling the excess alcohol to the alcohol source.

3. The method of claim 2 wherein a stoichiometric excess of alcohol is used.

4. The method of claim 3 which further comprises:
providing a proximal pre-heater in fluid communication with the distal pre-heater and the reactor, and a first flash drum, transferring the alcohol from the distal pre-heater to the proximal pre-heater, mixing the alcohol with the triglyceride to form the reaction mixture, and then transferring the reaction mixture to the reactor;
providing a proximal heat exchanger configured to transfer heat to the proximal pre-heater, the proximal heat exchanger in fluid communication with the reactor and the first flash drum; and
after the reaction is complete, directing a first proportion of the reaction products to the proximal heat exchanger and therefrom to the first flash drum, and directing a second proportion of the reaction products directly to the first flash drum.

5. The method of claim 4 wherein the proximal pre-heater is interposed the distal pre-heater and the reactor, the proximal pre-heater being at a temperature and pressure greater than that of the distal pre-heater but below about 180° C. and 1450 psi.

6. The method of claim 4 which further comprises:
providing a first intermediate pre-heater and a second intermediate pre-heater, the first intermediate pre-heater being in fluid communication with the distal pre-heater, and the second intermediate pre-heater being in fluid communication with the first intermediate pre-heater and the proximal pre-heater;
providing a first intermediate heat exchanger configured to transfer heat to the first intermediate pre-heater, the first intermediate heat exchanger in fluid communication with the first flash drum;
providing a second intermediate heat exchanger configured to transfer heat to the second intermediate pre-heater, the second intermediate heat exchanger in fluid communication with the first flash drum;
transferring the biofuel from the first flash drum to the first intermediate heat exchanger to heat the alcohol in the first intermediate pre-heater to a temperature and pressure above the distal pre-heater but below that of the second intermediate pre-heater;
collecting the biofuel from the first intermediate heat exchanger; and
transferring a first volume of the alcohol and glycerin gaseous mixture from the first flash drum to the second intermediate heat exchanger to pre-heat the alcohol in the second intermediate pre-heater to a temperature and pressure above that of the first intermediate pre-heater but below that of the proximal pre-heater.

7. The method of claim 6 which further comprises:
providing a second flash drum;
providing a distal heat exchanger configured to transfer heat to the distal pre-heater, the distal heat exchanger in fluid communication with the second flash drum;
transferring the first volume of the glycerin and alcohol mixture from the second intermediate heat exchanger to the second flash drum to condense the glycerin;
transferring a second volume of the glycerin and alcohol mixture from the first drum directly to the second drum to condense the glycerin;
collecting the glycerin from the second flash drum;
transferring the remaining gaseous alcohol to the distal heat exchanger to pre-heat the alcohol in the distal pre-heater;
delivering the so-recycled alcohol from the distal heat exchanger to the source of alcohol; and
mixing the recycled alcohol with the alcohol source.

8. The method of claim 6 wherein:
transesterification the reactants are an alcohol and an oil, the alcohol corresponding to the formula:
CₙH₂ₙ₋₁(OH)
wherein n ranges from about 1 to about 10 and the oil is a vegetable oil.

9. The method of claim 8 wherein the method is a continuous process.

10. The method of claim 2 wherein the reactor is angled with respect to its vertical axis.

11. The method of claim 2 where the alcohol is methanol.

12. (canceled)

13. A mobile unit assembly for manufacturing a biofuel by a transesterification reaction of a triglyceride and a stoichiometric excess of an alcohol where the reaction is carried out at a supercritical state, the assembly comprising:
a platform having substantially planar upper and lower surfaces;
a structural support, the structural support comprising a plurality of pillars and a plurality of struts, the pillars extending upwardly from the platform, and the struts extending between the pillars, the pillars and struts being secured to each other at their respective intersections;
an apparatus for manufacturing the biofuel, the apparatus comprising a source of an alcohol, a source of a triglyceride, at least one flash drum, at least one pre-heater, and a reactor;
wherein the apparatus is secured to the structural support such that the apparatus is braced for transport from one location to another.

14. The mobile unit assembly of claim 13 wherein the source of alcohol and the source of triglyceride each comprise a feed tank, each of the feed tanks being secured to the structural support.

15. The mobile unit assembly of claim 13 wherein the apparatus comprises at least one proportioning valve.

16. The mobile unit assembly of claim 13 wherein the reactor is angled with respect to its vertical axis.
